(19) United States
(12) Patent Application Publication
(10) Pub. No.: US 2025/0383592 A1
(43) Pub. Date: Dec. 18, 2025

(54) MEDIA PROMPTER

(71) Applicant: 360 Service Partners LLC, Greenwich, CT (US)

(72) Inventors: Daniel Macom, Greenwich, CT (US); Craig Jones, Greenwich, CT (US)

(21) Appl. No.: 18/745,106

(22) Filed: Jun. 17, 2024

(51) Int. Cl. G03B 21/10; G03B 15/12; G03B 21/14; G03B 21/28

(52) U.S. Cl. CPC G03B 21/10; G03B 15/12; G03B 21/145; G03B 21/28

(57) ABSTRACT

A media prompter may be provided by a media prompting system, including a monitor having a light emitting surface a pane having a first surface opposed to a second surface. The first surface has a reflection coefficient and a transmission coefficient with respect to light incident with the first surface, the reflection coefficient being greater than the transmission coefficient, an imaging device, having an imaging direction defined by a first direction vector, and a housing including opaque panels, in which the monitor, the pane, and the imaging device are disposed.

### BACKGROUND

Media prompting devices often employ two-way mirrors to reflect prompted media off of a reflective surface, while also imaging a subject through the reflective surface. Many of the limitations of media prompters correspond to the physical characteristics of the two-way mirror. In many cases, a balance must be struck between the brightness of the reflected media and the brightness of the image of the subject.

### SUMMARY

In a first embodiment, the present disclosure provides a media prompting system, including a monitor having a display surface configured to output light depicting media, a pane having a first surface opposed to a second surface. The pane has a reflection coefficient and a transmission coefficient with respect to light incident with the pane, the reflection coefficient not less than the transmission coefficient. The system further includes an imaging device, having an imaging direction defined by a first direction vector; and an opaque housing, in which the monitor, the pane, and the imaging device are disposed. The imaging device is oriented with respect to the pane such that the imaging direction is directed towards the second surface of the pane. The opaque housing includes an opening corresponding to the imaging direction. The monitor and the pane are oriented with respect to one another, such that the first surface reflects the light output from the display surface in a reflection direction defined by the first direction vector. The monitor and the opaque housing are oriented relative to the pane such that the display surface is concealed by the opaque housing from a field of view defined by a line of sight having a second direction vector, the second direction vector being an inverse of the first direction vector. A light absorbent material is disposed over a first portion of the second surface of the pane, and a second portion of the second surface of the pane remains uncovered by the light absorbent material and bounds of the second portion of the second surface of the pane correspond to a field of view of the imaging device.

In a variation of this embodiment, the first surface reflects the light output from the display surface, such that when the pane is viewed along the line of sight, the pane appears to display the media and conceals the imaging device.

In a variation of this embodiment, the imaging device is configured such that the imaging device captures images of light external to the housing that passes through the opening in the opaque housing, and through the second portion of the second surface of the pane.

In a variation of this embodiment, the imaging device and the pane are configured such that a portion of the light output from the display surface and transmitted through the first surface is distinct from the light captured by the imaging device.

In a variation of this embodiment, the light displayed by the display surface forms a depiction of natural language text.

In a variation of this embodiment, the pane has a trapezoidal profile, and the pane is oriented at an oblique angle relative to the first direction vector and the second direction vector, such that the pane appears to have a substantially rectangular profile in the field of view.

In a variation of this embodiment, the pane is oriented at an oblique angle relative to the first direction vector and the second direction vector, and the media depicted in the light output by the display surface is configured to have non-rectangular bounds, such that when the light is reflected from the first surface, the media appears to have rectangular bounds.

In a variation of this embodiment, the imaging device is a camera.

In another embodiment, the present disclosure provides a system, including a monitor having a display surface configured to output light depicting media, a pane having a first surface opposed to a second surface. The pane has a reflection coefficient and a transmission coefficient with respect to light incident with the pane, the reflection coefficient not less than the transmission coefficient. The system further includes an imaging device, having an imaging direction defined by a first direction vector. The imaging device and the pane are oriented relative to one another such that the imaging direction is directed toward the second surface. The monitor and the pane are oriented with respect to one another, such that the first surface reflects light emitted from the display surface in a reflection direction defined by the first direction vector. The pane has a trapezoidal profile, and the pane is oriented at an oblique angle relative to the first direction vector such that the pane appears to be substantially rectangular when the pane is viewed from a direction opposite to the reflection direction.

In a variation of this embodiment, the system further includes an opaque housing in which the monitor, the pane, and the imaging device are disposed. The opaque housing includes an opening corresponding to the reflection direction, and wherein the opaque housing comprises components selected from the group consisting of opaque panels, opaque curtains, and combinations thereof.

In a variation of this embodiment, the first surface reflects the light output from the display surface, such that when the pane is viewed from a direction opposite to the reflection direction, the pane appears to display the media and conceals the imaging device.

In a variation of this embodiment, the imaging device is configured to capture images of light that passes through the pane.

In a variation of this embodiment, a light absorbent material is disposed over a first portion of the second surface of the pane, and a second portion of the second surface of the pane remains uncovered by the light absorbent material and bounds of the second portion of the second surface of the pane correspond to a field of view of the imaging device.

In a variation of this embodiment, the pane is oriented at an oblique angle relative to the first direction vector and the second direction vector, and the media depicted in the light output by the display surface is configured to have non-rectangular bounds, such that when the light is reflected from the first surface, the media appears to have rectangular bounds.

In a variation of this embodiment, the imaging device and the pane are configured such that a portion of the light output from the display surface and transmitted through the first surface is distinct from the light captured by the imaging device.

In another embodiment, the present disclosure provides a method for media prompting, including providing an opaque enclosure, in which a monitor, a pane, and an imaging device are disposed, the enclosure defining an opening where the pane is configured to reflect a portion of light incident with a first surface of the pane, outputting an image via the monitor reflecting the image output by the monitor via the first surface of the pane, where the pane is obliquely angled relative to the monitor, such that the reflected image is directed towards the opening, and where the pane has a non-rectangular profile, such that the pane appears to have a rectangular profile when the pane is viewed through the opening; and capturing an images of light passing through the opening and through the pane via the imaging device, the imaging device directed towards a second surface of the pane, opposed to the first surface.

In a variation of this embodiment, a light absorbent material is disposed over a first portion of the second surface of the pane, and a second portion of the second surface of the pane remains uncovered by the light absorbent material and bounds of the second portion of the second surface of the pane corresponds to a field of view of the imaging device.

In a variation of this embodiment, the image includes natural language text.

In a variation of this embodiment, the non-rectangular profile is a trapezoidal profile.

In a variation of this embodiment, the image as output from the monitor is configured to have non-rectangular bounds, such that when the image is reflected from the first surface of the pane, the reflected image appears to have rectangular bounds.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a schematic view of a media prompting system, according to embodiments of the present disclosure.

FIG. 2 illustrates the schematic view of the media prompting system of FIG. 1, when interacted with by a subject, according to embodiments of the present disclosure.

FIGS. 3A and 3B illustrate normal and perspective views of a reflective pane, according to embodiments of the present disclosure.

FIGS. 4A and 4B illustrate a perspective view of the media prompting system, according to embodiments of the present disclosure.

FIG. 5 illustrates a method of media prompting, according to embodiments of the present disclosure.

### DETAILED DESCRIPTION

The present disclosure provides media prompters, which may provide improved imaging and display qualities over existing systems by the implementation of several design aspects. As teleprompting systems often employ two-way mirrors, ambient lighting conditions may have substantial effects on the case of use of a system. Two-way mirrors have two opposed surfaces, where a given surface (e.g. bright side) appears to be reflective (e.g., as a mirror) when the given surface is more brightly lit than the surface opposed to the given surface (e.g. dim side), and the surface opposed to the given surface appears to be transparent (e.g. as a window, or glass pane). Reflectivity coefficients (R) correspond to an amount of incident light reflected by a surface. An associated metric, a transmission coefficient (T), corresponds an amount of incident light that passes through the surface. For any surface, RL+TL=L, where L represents the total amount of light incident with the surface (e.g., incident light not absorbed by the surface). Thus, surfaces with large reflection coefficients have correspondingly smaller transmission coefficients and vice versa. The transparent/reflective effect is achieved when the lighting on the dim side is reduced, such that the amount of light reflected by the bright side is greater than the amount of light passing through the two-way mirror from the dim side, and the amount of light transmitted from the bright side to the dim side is greater than the amount of light reflected by the dim side. The transparent/reflective effect may be improved when light sources on the dim side are removed entirely. As teleprompting systems often employ two-way mirrors, ambient light may interfere with the prompted media, which may impair a user's ability to view or read the prompted media (e.g. reflected by the two-way mirror), and ambient light may also interfere with the ability of an imaging device (e.g. a camera) to image the user (e.g. from the dim side of the two-way mirror), affecting image and video quality.

Furthermore, media prompting systems often include a monitor which displays the media to be prompted to a reflective pane. In many instances, the pane is oriented at a 45-degree angle relative to both the user and the monitor, where the monitor remains in the user's line of sight while viewing the media reflected on the pane, which may be a source of distraction to the user. Said differently, the monitor source is often positioned on the bottom of the media prompter and presents the image upwards to the reflective pane.

In some examples, the media prompting system may display any media that is displayed on a computer monitor, or display screen, e.g., text, images, a video feed, contents of a computer screen, etc. This may be particularly advantageous for video conferencing, or video calls. Oftentimes, when participating in a video call with a standard webcam (e.g., or the like), a user's line of sight is directed towards a screen, and an imaging direction of the webcam is not aligned with the user's line of sight as the webcam is frequently disposed above the screen, which may give the appearance to a second user participating in the video call that the user is avoiding eye contact. The media prompting system of the present disclosure may allow a user to view their screen (e.g., the video feed of the video call), while appearing to the second user as though they are making eye contact with the user when the second user views their respective screen, as the line of sight of the user and the imaging direction of the imaging device are aligned.

In a first design aspect, the components of the media prompter may be contained in an opaque enclosure, which may be constructed of opaque panels, curtains, or other components which are configured to block light from external sources from interfering with the two-way mirror. The housing may include a window, or other orifice by which the media may be directed towards a user, and through which the user may be imaged by an imaging device. The opaque housing may reduce ambient light interference with both reflected media and imaging by the imaging device.

In a second design aspect, the monitor is disposed above the reflective pane, and oriented such that the display surface of the monitor is not within a field of view of the user when the user engages with the media prompting system. The position of the monitor may decrease visual distractions to the user, and result in an improved course of use.

In a third design aspect, the reflective pane includes a light-absorbent backing, which may block light from passing through the two-way mirror from the dim side. By reducing the transmission of light from the dim side of the two-way mirror, the reflected image quality of the reflective pane may be increased. Furthermore, the light-absorbent backing may also be employed to define a field of view of the imaging device and provide a focused aperture for the imaging device to capture images through.

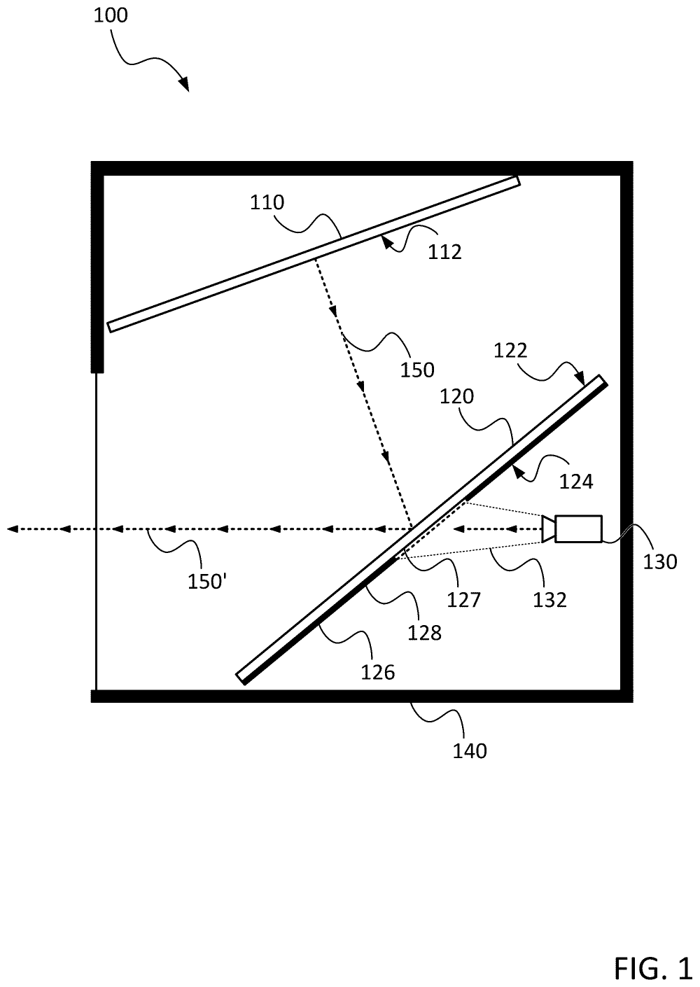

FIG. 1 illustrates a schematic view of a media prompting system 100, (e.g. media prompting device, media prompter) having a monitor 110, a reflective pane 120, and an imaging device 130 and a housing 140.

According to some embodiments, the monitor 110 emits light 150 from a display surface 112. The emitted light 150 is emitted in a display direction defined by a display direction vector V_{D}, where V_{D} is the normal of the display surface 112. In some examples, V_{D} is directed towards the first surface 122 of the reflective pane 120, where the emitted light 150 is reflected by the first surface 122, becoming reflected light 150′, having a reflection direction defined by a reflection direction vector V_{R}. In some examples, the monitor 110 and reflective pane 120 are oriented obliquely relative to one another, such that V_{R} is directed out of an opening 144 in the housing 140.

According to some embodiments, the first surface 122 has a first reflection coefficient R₁ and a first transmission coefficient T₁. The apparent brightness (e.g to a user viewing the reflective pane 120) of the reflected light 150′ may depend on R₁, and the apparent brightness of the reflected light 150′ may increase and decrease corresponding to respective increases and decreases in R₁. According to some embodiments, R₁ is not less than T₁.

According to some embodiments, the imaging device 130 is disposed on an opposite side of the reflective pane 120, such that the imaging device 130 is oriented towards the second surface 124 of the reflective pane 120. The imaging device may have an imaging direction, defined by an imaging direction vector V_{I} (e.g., first direction vector), where the imaging direction is a central axis for an imaging field of view (FOV) 132 of the imaging device 130. The imaging device 130 may detect light within the imaging FOV 132, where the light within the imaging FOV 132 has a characteristic direction vector V_{L}, where V_{L}, is the inverse of V_{I}, such that V_{L}=−V_{I}. The term “characteristic direction vector” is used to refer to the net direction of the light within the imaging FOV 132 received by the imaging device 130, understanding that individual photons of the light may travel in distinct and different directions.

According to some embodiments, the reflection direction may be configured to align with the imaging direction, such that V_{I} is equivalent to V_{R} (e.g. the imaging direction and the reflection direction are parallel). When V_{I} and V_{R} are equivalent, the imaging device 130 may image a subject to which the reflected light 150′ is directed.

According to some embodiments, the housing 140 may be configured to block light external to the housing 140 from entering the housing 140 and block light internal to the housing 140 from exiting the housing 140, in directions other than those corresponding to the reflection direction and the imaging direction, such that a subject may view the reflective pane 120 along the reflection direction, and the subject may be imaged by the imaging device 130 in the same direction. The housing 140 may be composed of opaque components 142, which substantially enclose the monitor 110, the imaging device 130, and the pane 120 in a defined volume. In some examples, the opaque components may be selected from panels, curtains, and the like. The opaque components 142 define an opening only on a face of the housing 140 corresponding to the reflection direction.

As described above, the apparent brightness of the reflected light 150′ is increased by increasing R₁. The apparent brightness of the subject when images is increased by increasing T₁. As R₁ and T₁ are inversely related, the brightness of the reflected light 150′ (e.g., with respect to the subject) and the brightness of the subject (e.g., with respect to the imaging device 130) are at odds.

When the housing 140 blocks light external to the housing 140 from entering the housing 140, the imaging device 130 is exposed only to light that is transmitted through the first surface 122, reducing interference of ambient light when a subject is imaged by the imaging device 130. Thus, the imaging device 130 may operate with the first surface 122 having a reduced T₂ relative to an imaging device exposed to ambient light, which corresponds to an increased R₁, such that the apparent brightness of the reflected light 150′ may be increased to the subject.

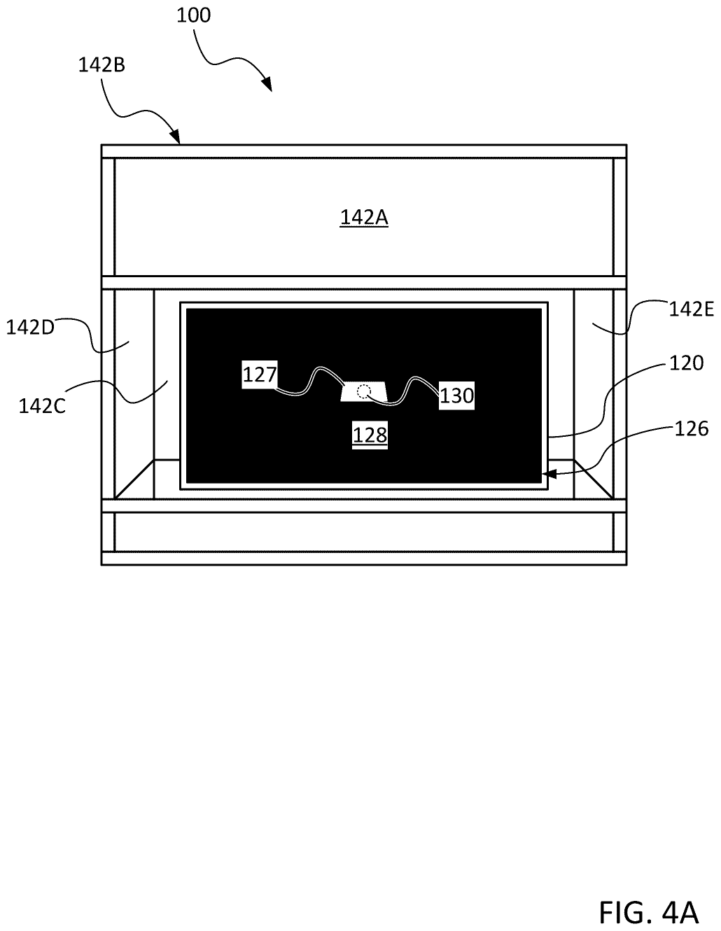

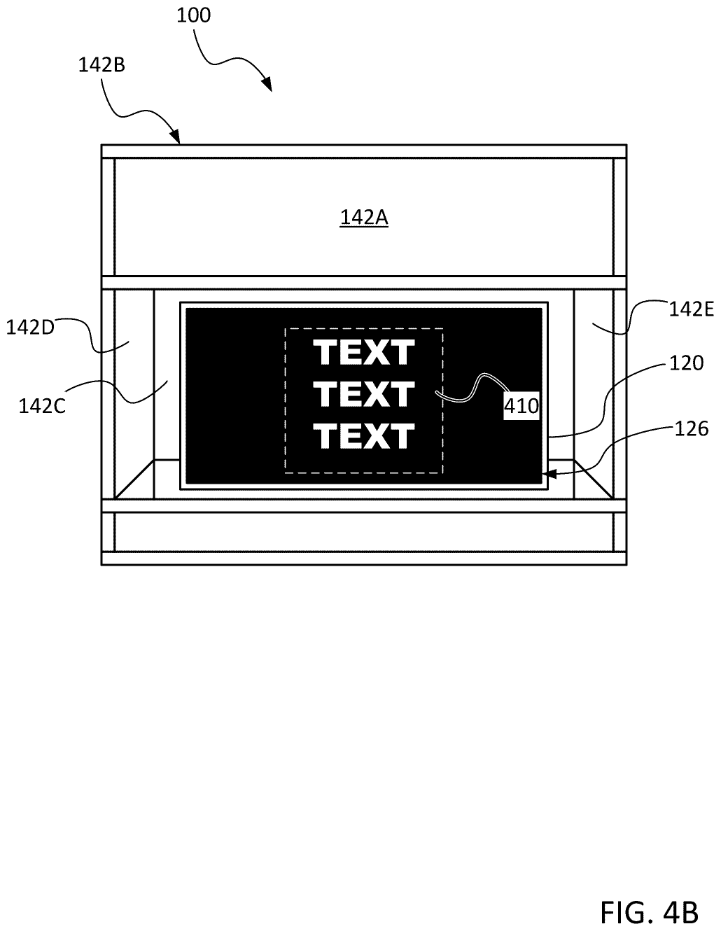

According to some embodiments, the amount of ambient light to which the imaging device 130 is exposed may be further reduced by restricting the imaging FOV 132 to an uncovered portion 127 (e.g., second portion) of the second surface 124 of the reflective pane 120, by providing a light absorbent material 126 on a covered portion 128 (e.g., first portion) of the second surface 124 of the reflective pane 120, where the covered portion 128 defines the bounds of the uncovered portion 127 (See FIG. 4A) (e.g., such that the open portion is unobstructed by the light absorbent material 126). The light absorbent material 126 may limit the imaging FOV 132 of the imaging device 130 to a more focused range, as well as limiting light entering the area behind the reflective pane 120 in which the imaging device 130 is disposed, which may further reduce a lower bound of the T_{I} required for the imaging device to operate.

According to some embodiments, the imaging device 130 and the light absorbent material 126 are oriented such that the portion of emitted light 150 from the monitor 110 that is transmitted through the reflective pane 120 is not incident with the imaging device 130, which may preserve image quality of the subject. Furthermore, the light absorbent material 126 may further increase the apparent brightness of the reflected light 150′, as the portion of emitted light 150 from the monitor 110 that is transmitted through the reflective pane 120 may be absorbed by the light absorbent material 126. In an absence of the light absorbent material 126, the portion of emitted light 150 from the monitor 110 that is transmitted through the reflective pane 120 may reflect from the area behind the reflective panel 120 and pass through the second surface 124 to the first surface 122, interfering with the reflected light 150′.

In some examples, the system 100 may include a plurality of imaging devices. For enabled function of more than one imaging device 130, the system may be modified such that there are several uncovered portions 127 of the second surface 124 of the pane 120, corresponding to the several FOVs 132 of the several imaging devices 130. Furthermore, the opening in the housing may be modified to accommodate several FOVs 132 of the several imaging devices 130.

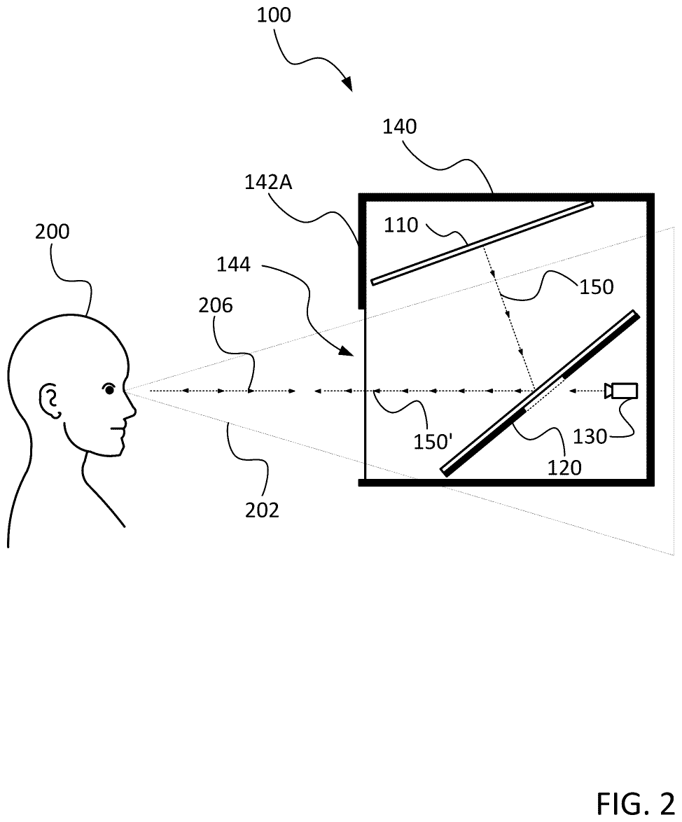

FIG. 2 illustrates the schematic view of the media prompting system 100 of FIG. 1, where a subject 200 is interacting with the system 100, according to embodiments of the present disclosure. The subject 200 has a subject FOV 202 defined by a line of sight 206, defined by a sight direction vector V_{S} (e.g., second direction vector). When the system 100 is operated as illustrated in FIG. 2, V_{I} and V_{R} are parallel to one another, and anti-parallel to V_{S}, an Vₛ is the inverse of V_{I}, such that V_{S}=−V_{I}. When V_{I} and V_{R} are parallel to one another, and anti-parallel to Vs, the subject 200 may be considered to be in an engaged position with the system 100. In the engaged position, the monitor 110 is disposed above the reflective pane 120 (e.g. relative to gravity) and obscured by a housing panel 142A. Thus, the monitor 110 is concealed from the subject FOV 202, which may alleviate the subject 200 from a potential source of visual distraction when engaging with the system 100.

In some examples, the system 100 further includes other media devices, such as microphones, lighting apparatuses and the like. The lighting apparatuses may be provided outside the housing 140, such that the subject 200 may be illuminated by the lighting apparatuses when imaged by the imaging device 130, and the light from the lighting apparatuses is substantially prevented from entering the housing 140 by the opaque components 142.

In some examples, the system 100 may include structural features, such as a stand, a frame, a chassis, legs, or similar conventional structures, which may be employed to alter or adjust a position of the system (e.g., a height), which may be increase case of use for a user orienting the system relative to the user, such that the user may comfortably interact with the system in the engaged position.

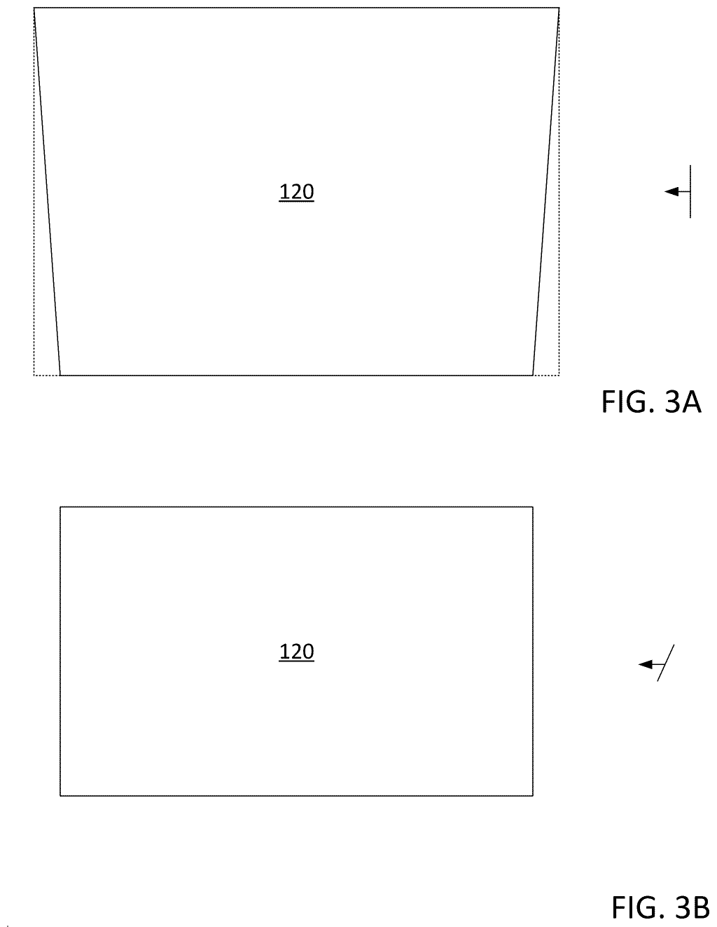

FIG. 3A illustrates a profile view of a reflective pane 120, and FIG. 3B illustrates a perspective view of the reflective pane 120, according to embodiments of the present disclosure. According to some embodiments, the reflective pane 120 has a non-rectangular profile. As used herein “profile” is used to refer to the shape of a component or surface, when viewed orthogonally to the component or surface. As the reflective pane 120 is angled obliquely with respect to the subject 200 (See FIG. 2), a top side 302 of the reflective pane 120 will be further away from the subject 200 than a bottom side 304 of the reflective pane 120. In order for the reflective pane 120 to appear rectangular (e.g., as would a typical screen, as illustrated in FIG. 3B) in the subject FOV 202, the profile of the reflective pane 120 is trapezoidal, as illustrated in FIG. 3A. When the reflective pane 120 is oriented in the media prompting system 100 such that the longer base of the trapezoidal profile is above the smaller base, the longer base of the trapezoidal profile is further away from the subject than the shorter base, resulting in a perspective distortion where the reflective pane 120 appears to have a rectangular profile to the subject 200. This disclosure further contemplates embodiments where the reflective pane 120 includes profiles of other shapes accounting for perspective distortion (e.g., an elliptical profile to appear circular).

According to some embodiments, the emitted light 150 (e.g., the media depicted the emitted light 150) from the display surface 112 of the monitor 110 may be distorted (e.g., when viewed normal to the display surface) such that when the emitted light 150 is reflected by the reflective pane 120, the reflected light 150′ (e.g., the media depicted by the reflected light 150′) appears undistorted when viewed by a subject in the engaged position. Said differently, as the reflective pane 120 may have non-rectangular bounds, media displayed by the monitor may also be configured to have corresponding non-rectangular bounds, such that when the emitted light 150 is reflected by the reflective pane 120, the reflected media communicated by the reflected light 150′ appears to have rectangular bounds when viewed by a subject 200 in the engaged position.

The perspective distortion of the reflective pane 120 may be calculated based on an idealized engaged position, in which a distance between the subject 200 and the system 100 is predefined.

In some examples, the emitted light 150 (e.g., the media depicted the emitted light 150) from the display surface 112 of the monitor 110 may be flipped, mirrored, inverted, or otherwise modified, such that the media depicted the reflected light 150′ appears to be regular (e.g., English language text is presented from left to right, etc.) when viewed by a subject 200 in the engaged position.

In some examples, the reflective pane 120 has rectangular bounds, and the bounds of the reflective pane 120 are not used to define the bounds of the media reflected by the reflective pane 120. Said differently, the reflective pane 120 may occupy an entire plane of the housing 140, such that the bounds of the reflective pane 120 are not apparent to a user. In such examples, the monitor may output media having a predefined perspective distortion, where the bounds of the media are defined by the monitor alone and appear rectangular to the subject 200.

FIGS. 4A and 4B illustrate perspective views of a media prompting system 100, as may be viewed by a subject 200 in the engaged position. FIG. 4A illustrates a perspective view of the system 100 when the system 100 is off, as may be the case when the monitor 110 is not emitting light 150, and thus the reflective pane 120 is not reflecting light 150′ from the monitor. The housing 140 includes a housing panel 142A which obscures the monitor 110 from the subject FOV 202, and housing panels 142B-E, which contribute to insulating the system 100 from ambient light. Also viewable in FIG. 4A are the open portion 127 and the obscured portion 128 of the second surface 124 of the reflective pane (as viewed through the first surface 122), where the imaging device 130 is viewable through the first portion. Note that while the imaging device 130 is illustrated as viewable through the reflective pane 120 in FIG. 4A, the imaging device 130 would be substantially concealed from the view of a subject 200 by the reflective pane 120 in practice.

FIG. 4B illustrates a perspective view of the media prompting system 100, as may be viewed by a subject 200 in the engaged position when the system of on, as may be the case when the monitor 110 is emitting light 150 to be reflected by the reflective pane 120, according to embodiments of the present disclosure. When the media prompting system 100 is engaged, the reflected light 150′ appears substantially as though the light 150′ is being emitted from a display. The housing 140 substantially prevents ambient light from entering the housing 140, and the portion of emitted light 150 from the monitor 110 that is transmitted through the reflective pane 120 may be absorbed by the light absorbent material 126 from passing through the second surface 124 and potentially interfering with the reflected light 150′.

The reflected light 150′, and the emitted light 150 may contain, communicate, or otherwise depict media 410 to be displayed to the subject 200. Such media 410 may include images, symbols, or, as illustrated in FIG. 4B, natural language text. The media 410 may include predetermined perspective distortion such that the bounds of the media 410 appear rectangular when viewed by the subject 200. In some examples, the perspective distortion may be implemented according to a predetermined or variable distance between the system 100 and the subject 200.

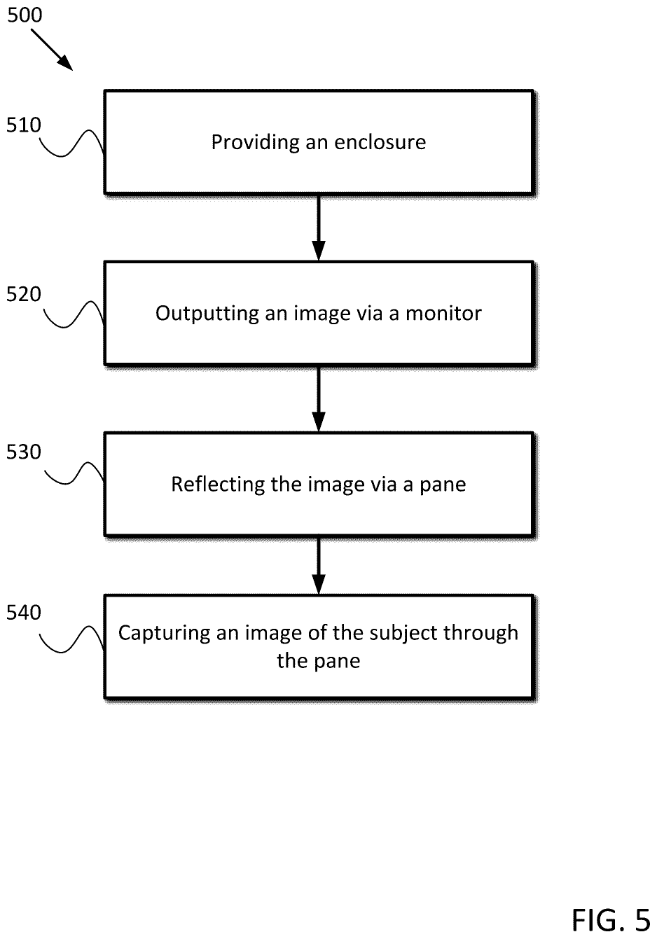

FIG. 5 illustrates a flowchart for a method 500 of media prompting, according to embodiments of the present disclosure.

Block 510 of the method 500 describes providing an opaque enclosure (e.g. housing 140). The opaque enclosure may have disposed therein a monitor (e.g. monitor 110), a pane (e.g. reflective pane 120), and an imaging device (e.g., imaging device 130). The opaque enclosure may include an opening.

Block 520 of the method 600 describes outputting an image via the monitor, according to embodiments of the present disclosure. At block 520, the monitor may display an image, (e.g., images, a video feed, natural language text, and the like). The image may be a form of media depicted by light output from a display surface of the monitor.

Block 530 of the method 500 describes reflecting the image output by the monitor via a first surface (e.g., first surface 122) of a pane (e.g. reflective pane 120) configured to reflect a portion of light incident with a first surface of the pane. The pane and the monitor may be oriented obliquely relative to one another, such that a display surface (e.g. display surface 112) of the monitor is oriented in a direction substantially opposed to the direction in which the light is reflected form the pane. In some examples, the pane is oriented at an oblique angle relative to a subject and the monitor, such that the image reflected by the pane is directed towards a FOV of a subject (e.g. subject 200). In some examples, the pane has a non-rectangular profile, such that when viewed by a subject at the oblique angle, the non-rectangular pane appears to be rectangular in the FOV of the subject. In some examples, the image displayed by the monitor includes perspective distortion corresponding to the oblique angle of the pane, such that when the image reflected by the pane is viewed by the subject the image appears to have rectangular bounds in the FOV of the subject.

Block 540 of method 500 describes capturing an image of the subject via an imaging device disposed on a side of the pane opposite to the subject, according to embodiments of the present disclosure. In some examples, a camera (e.g. imaging device 130) is disposed on a side of the pane opposite from the side on which the image from the monitor is reflected, and is oriented such that the camera may captures images of light passing through the opening in the housing and through the pane. In such embodiments, the pane is partially transparent (e.g. such as reflective pane 120), such that light reflected by the subject is observable to the camera through the pane.

Certain terms are used throughout the description and claims to refer to particular features or components. As one skilled in the art will appreciate, different persons may refer to the same feature or component by different names. This document does not intend to distinguish between components or features that differ in name but not function.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

1. A media prompting system, comprising:
a monitor having a display surface configured to output light depicting media;
a pane having a first surface opposed to a second surface, wherein the pane has a reflection coefficient and a transmission coefficient with respect to light incident with the pane, the reflection coefficient not less than the transmission coefficient;
an imaging device, having an imaging direction defined by a first direction vector; and
an opaque housing, in which the monitor, the pane, and the imaging device are disposed;
wherein the imaging device is oriented with respect to the pane such that the imaging direction is directed towards the second surface of the pane,
wherein the opaque housing includes an opening corresponding to the imaging direction,
wherein the monitor and the pane are oriented with respect to one another, such that the first surface reflects the light output from the display surface in a reflection direction defined by the first direction vector,
wherein the monitor and the opaque housing are oriented relative to the pane such that the display surface is concealed by the opaque housing from a field of view defined by a line of sight having a second direction vector, the second direction vector being an inverse of the first direction vector,
wherein a light absorbent material is disposed over a first portion of the second surface of the pane, and a second portion of the second surface of the pane remains uncovered by the light absorbent material, and bounds of the second portion of the second surface of the pane correspond to a field of view of the imaging device.

2. The system of claim 1, wherein the first surface reflects the light output from the display surface, such that when the pane is viewed along the line of sight, the pane appears to display the media and conceals the imaging device.

3. The system of claim 1, wherein the imaging device is configured such that the imaging device captures images of light external to the housing that passes through the opening in the opaque housing, and through the second portion of the second surface of the pane.

4. The system of claim 3, wherein the imaging device and the pane are configured such that a portion of the light output from the display surface and transmitted through the first surface is distinct from the light captured by the imaging device.

5. The system of claim 1, wherein the light displayed by the display surface forms a depiction of natural language text.

6. The system of claim 1, wherein the pane has a trapezoidal profile, and the pane is oriented at an oblique angle relative to the first direction vector and the second direction vector, such that the pane appears to have a substantially rectangular profile in the field of view.

7. The system of claim 1, wherein the pane is oriented at an oblique angle relative to the first direction vector and the second direction vector, and the media depicted in the light output by the display surface is configured to have non-rectangular bounds, such that when the light is reflected from the first surface, the media appears to have rectangular bounds.

8. The system of claim 1, wherein the imaging device is a camera.

9. A system, comprising:
a monitor having a display surface configured to output light depicting media;
a pane having a first surface opposed to a second surface, wherein the pane has a reflection coefficient and a transmission coefficient with respect to light incident with the pane, the reflection coefficient not less than the transmission coefficient; and
an imaging device, having an imaging direction defined by a first direction vector;
wherein the imaging device and the pane are oriented relative to one another such that the imaging direction is directed toward the second surface;
wherein the monitor and the pane are oriented with respect to one another, such that the first surface reflects light emitted from the display surface in a reflection direction defined by the first direction vector,
wherein the pane has a trapezoidal profile, and the pane is oriented at an oblique angle relative to the first direction vector such that the pane appears to be substantially rectangular when the pane is viewed from a direction opposite to the reflection direction.

10. The system of claim 9, further comprising an opaque housing in which the monitor, the pane, and the imaging device are disposed, wherein the opaque housing includes an opening corresponding to the reflection direction, and wherein the opaque housing comprises components selected from the group consisting of opaque panels, opaque curtains, and combinations thereof.

11. The system of claim 9, wherein the first surface reflects the light output from the display surface, such that when the pane is viewed from a direction opposite to the reflection direction, the pane appears to display the media and conceals the imaging device.

12. The system of claim 9, wherein the imaging device is configured to capture images of light that passes through the pane.

13. The system of claim 9, wherein a light absorbent material is disposed over a first portion of the second surface of the pane, and a second portion of the second surface of the pane remains uncovered by the light absorbent material, and bounds of the second portion of the second surface of the pane correspond to a field of view of the imaging device.

14. The system of claim 9, wherein the pane is oriented at an oblique angle relative to the first direction vector and the second direction vector, and the media depicted in the light output by the display surface is configured to have non-rectangular bounds, such that when the light is reflected from the first surface, the media appears to have rectangular bounds.

15. The system of claim 9, wherein the imaging device and the pane are configured such that a portion of the light output from the display surface and transmitted through the first surface is distinct from the light captured by the imaging device.

16. A method for media prompting, comprising:
providing an opaque enclosure, in which a monitor, a pane, and an imaging device are disposed, the enclosure defining an opening,
wherein the pane is configured to reflect a portion of light incident with a first surface of the pane;
outputting an image via the monitor;
reflecting the image output by the monitor via the first surface of the pane,
wherein the pane is obliquely angled relative to the monitor, such that the reflected image is directed towards the opening, and
wherein the pane has a non-rectangular profile, such that the pane appears to have a rectangular profile when the pane is viewed through the opening; and
capturing an image of light passing through the opening and through the pane via the imaging device, the imaging device directed towards a second surface of the pane, opposed to the first surface.

17. The method of claim 16, wherein a light absorbent material is disposed over a first portion of the second surface of the pane, and a second portion of the second surface of the pane remains uncovered by the light absorbent material and bounds of the second portion of the second surface of the pane corresponds to a field of view of the imaging device.

18. The method of claim 16, wherein the image includes natural language text.

19. The method of claim 16, wherein the non-rectangular profile is a trapezoidal profile.

20. The method of claim 16, wherein the image as output from the monitor is configured to have non-rectangular bounds, such that when the image is reflected from the first surface of the pane, the reflected image appears to have rectangular bounds.
